(19) United States
(12) Patent Application Publication
(10) Pub. No.: US 2006/0210761 A1
(43) Pub. Date: Sep. 21, 2006

(54) Interactive surface

(76) Inventors: Gianfranco Barban, Gallarate (IT); Stefano Grimaldi, Milan (IT)

Correspondence Address: STITES & HARBISON, PLLC, 400 W MARKET ST, SUITE 1800, LOUISVILLE, KY, 40202-3352, US

(21) Appl. No.: 11/374,755

(22) Filed: Mar. 14, 2006

(30) Foreign Application Priority Data
Mar. 15, 2005 (IT) VA/2005/A/0017

(51) Int. Cl. B32B 3/02

(52) U.S. Cl. 428/68

(57) ABSTRACT

This invention concerns a furnishing article, like interactive surfaces, to be used as coating for floors and walls or as upper parts of furniture such as tables, stools and the like, the afore mentioned furnishing article being suitable for achieving particular aesthetic results, like changing colour and/or design after simply touching the surface itself in addition to pushing the said surface more forcefully. This interactive surface, which includes a first flexible transparent or translucent plate (3) combined with a second plate (2) having the same surface as the first plate (3), so that the first mentioned plate can be coupled with the second plate (2) along their perimeter, in order to create between said first and the second plate a thin meatus (4), filled with at least one liquid able to move inside said meatus (4) after pressure is applied on said first upper plate (3) tending to move it closer to the second lower plate (2), so said second lower plate becomes visible though said first upper transparent or translucent plate (3), is characterized by the fact that the first upper plate (3) is made of polymeric material and that said at least one liquid is insulating and contains solid suspended particles able to reflect the light in various directions, according to their orientation, the said orientation can be changed by touching the surface and/or pushing on it.

This invention concerns a furnishing article, like interactive surfaces, to be used as coating for floors and walls or as upper parts of furniture such as tables, stools and the like, the afore mentioned furnishing article being suitable for achieving particular aesthetic results, like changing colour and/or design after simply touching the surface itself in addition to pushing the said surface more forcefully. Furnishing articles are known, to be used like coatings and floorings, or such as tables surfaces, shelves and the like, which have the ability to interact with people, changing aesthetic aspects according to the actions carried out on them. Said articles, of a substantial two-dimensional development, could be defined as “interactive surfaces” because, for example, if you run your hands on the surface, pushing on it at the same time interesting aesthetic results can be achieved, such as localised colour changes or energetic mixtures of colours that will not join together.

Said products, of the known technique include a couple of combined plates in order to create a chamber of a very small thickness (also lower than one millimetre), said chamber being filled with a coloured liquid and at least one of the two plates being transparent and the other being coloured with a different colour from the one of the contained liquid. An object created in this way has the same colour as the one of the contained liquid, while when you press the transparent plate and it approaches the coloured one, the contained liquid is moved away, the plates touch each other and the more the liquid moves away the more the plates approach each other and the colour gets more visible from the lower plate. The obtained effect, for example by using the said furnishing object as a tile for floors, is that the steps of people who walk on it are highlighted by a tile colour change where the footsteps are. Of course, soon after the pressure, the liquid will tend to go back to its original position re-establishing the tile colour. The liquid flow speed, either when it changes its original position or when it goes back to it, is caused by its viscosity and by the plates' stiffness. The precision of the footstep “drawing” essentially depends on the upper plate's stiffness. Basically, walking on a floor realised with the said tiles, you can see footsteps that then disappear more or less rapidly, creating an effect of footsteps, which follow the person who is walking, and then which disappear.

This kind of tile is usually used in exhibitions, show-rooms or clubs such as discos, dancing clubs and the like, getting nice aesthetic effects. In particular, in case of low and psychedelic lights, this product creates particular effects if the colour of the lower plate is luminescent, in such a way that, by discovering it by the effect of the applied pressure, it shines in the dark.

If you want to use said interactive surface like coating for tables and the like, a great part of its effectiveness will be lost, because it is not easy to apply the necessary pressure with a hand to move away the liquid and uncover the lower plate. In these cases, it obviously requires the use of softer plates and of liquids of a lower viscosity, yet, the created effects are limited, unless a pressure, usually too strong for a hand, is applied.

A variant of the technique consists in introducing into the chamber two immiscible liquids of different colours. In this way interesting aesthetic effects are achieved, because the pressure applied on the upper plate causes the movements of the two liquids and the colour “crushing” effect, with the mixing up of a myriad of little coloured particles which however keep their colour.

The aim of this invention is to create a product suitable to get particular aesthetic effects also where weak or no pressure at all is applied, said effects, even if they are different from those which can be achieved with the known technique, being anyway traced to marks left by objects which might only touch on the upper plate. The aim is achieved by a composition according to claim 1, that is to say the introduction into the meatus existing between the two plates of at least one liquid which creates the suspension of particles suitable to reflect the light in different directions according to the orientation they have; said orientation might be changed through actions of electric or mechanic kind on the particles themselves. Actions of the electric kind are carried out by the simple friction of the outer surface of one of the plates delimitating the meatus, while actions of the mechanic kind are gotten by compressing the two plates in order to move them closer to each other, causing the moving of the combined liquid to the area where this pressure is applied and the surrounding areas.

Briefly, the particles in suspension in the liquid, which substantially have a two-dimensional shape, and consequently reflect the light in different directions according to their orientation, are orientated with their main dimension to a parallel orientation to the line of the electric field which is generated by rubbing the outer plate surface, consequently with an orientation substantially perpendicular to said plates, while they display with the main dimension in a parallel way to the liquid flow, when it is made to move by the pressure applied on the plates, that is with a parallel orientation to said plates.

This orientation change allows the incident light to be reflected in different orientations. If the particles are displayed with the main dimension in a parallel way to the upper plate surface, they will reflect the light toward the outward and the surface will appear luminous, while if said particles are set out with the main dimension to a orthogonal orientation to said upper plate, they will reflect the light towards the inside and consequently the surface will appear dark.

Now the invention is going to be described, with an illustrative and not limitative aim, according to a preferred embodiment and with reference to the figures here attached:

FIG. (a, b) 1 show an interactive surface according to the invention from which the top of the desk is gotten;

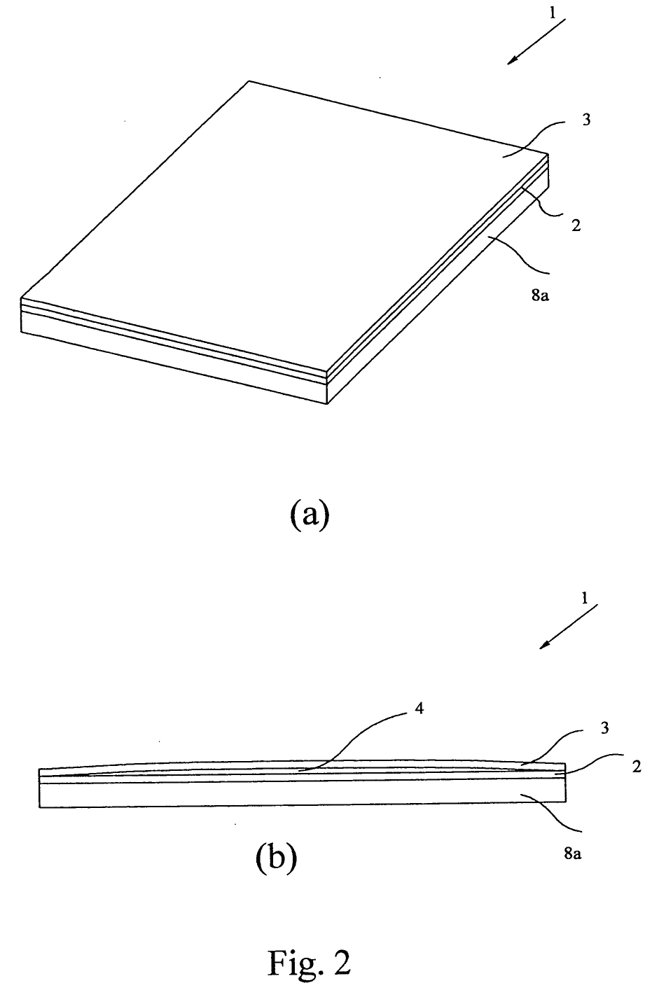

FIGS. 2 (a, b) show an interactive surface according to the invention from which a floor tile is gotten;

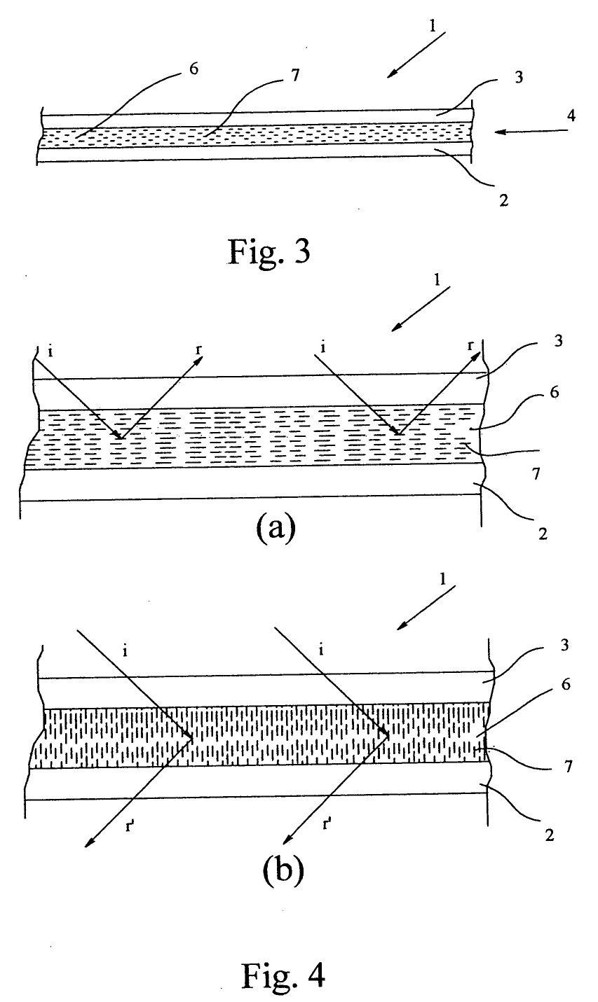

FIG. 3 shows the meatus in which is contained the liquid containing the reflecting particles in suspension;

FIGS. 4 (a, b) show the way according to which the interactive surface, according to the invention, changes its luminosity;

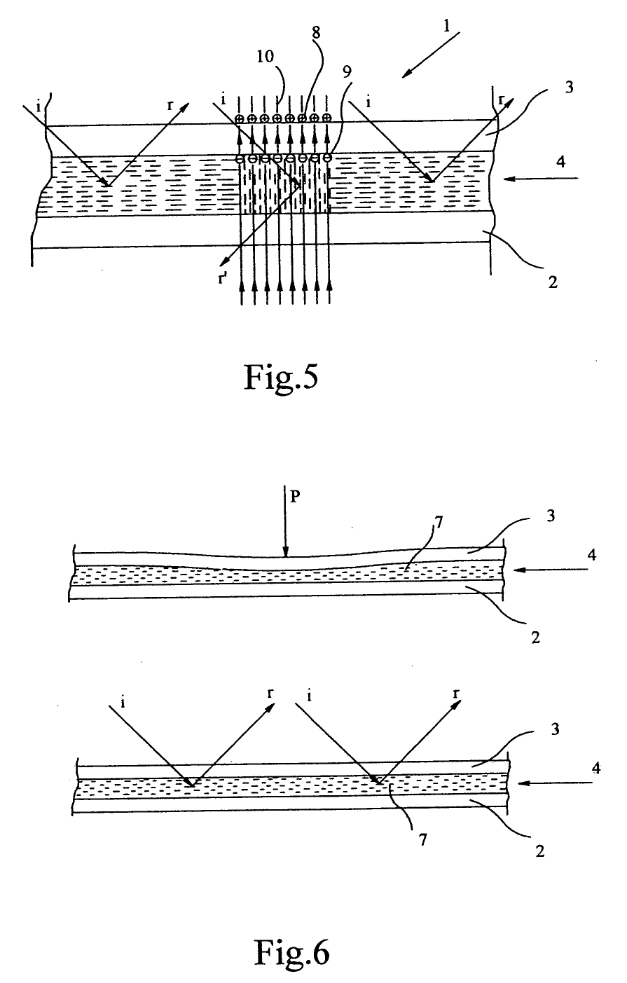

FIG. 5 shows in which way the particles in suspension in the liquid are perpendicularly orientated to the surface;

FIGS. 6 (a, b) show in which way the particles in suspension in the liquid are parallelly orientated to the surface;

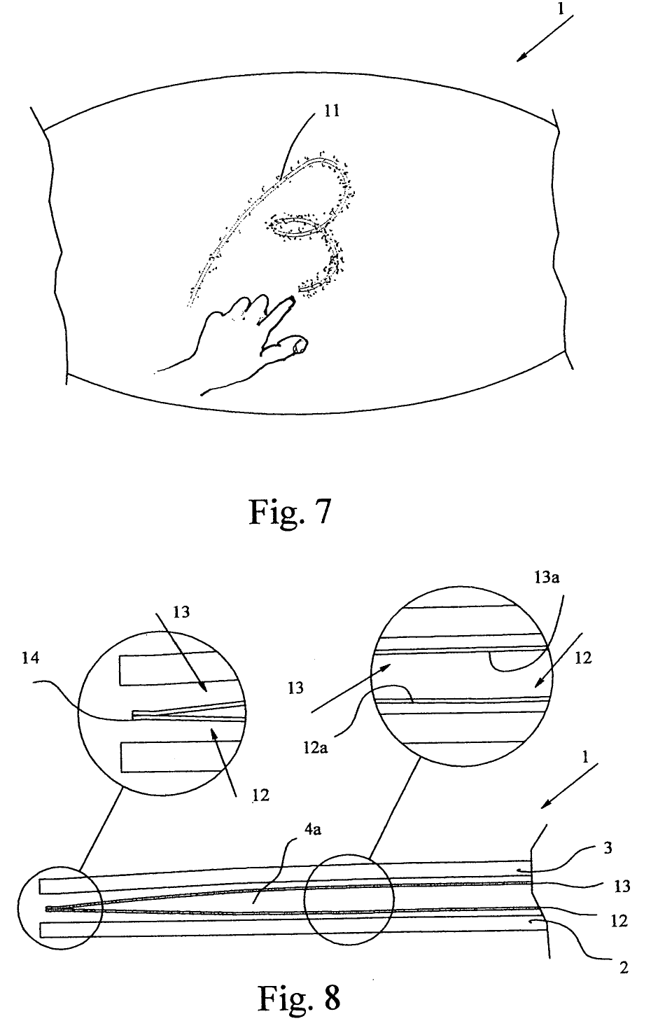

FIG. 7 shows how a picture is drawn on an interactive surface according to the invention;

FIG. 8 shows a particular article according to a variant.

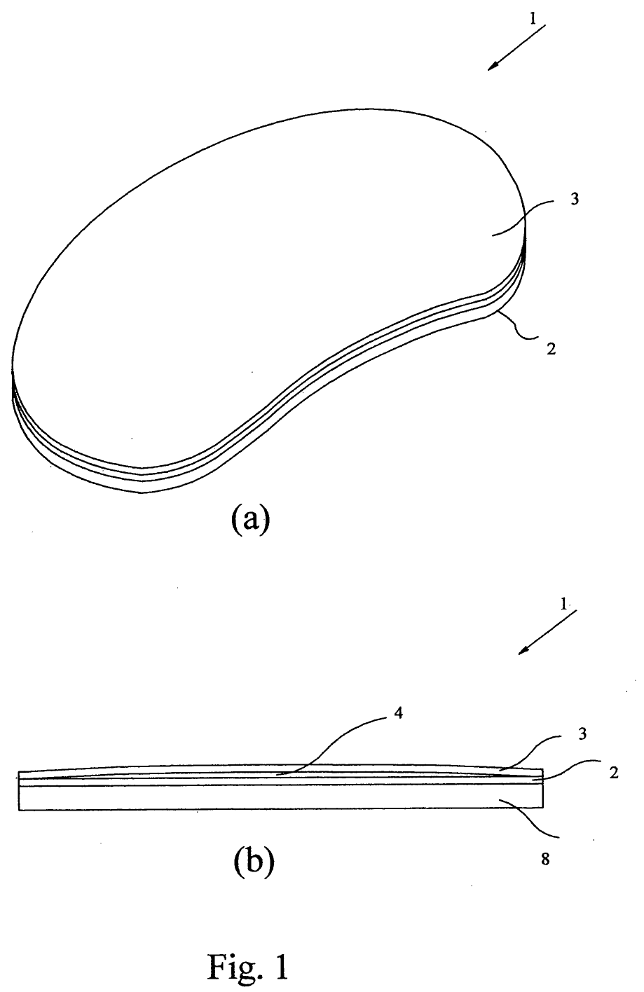

With reference to FIGS. 1 (a, b), in (1) is shown respectively a perspective and a section view of an interactive surface according to the invention. The considered case is a table top, e.g. a desk. Said interactive surface (1) includes a lower plate (2) and an upper plate (3), said plates (2) and (3) having the same shape and surface and being linked between them in correspondence to the perimeter, e.g. by welding or bonding, so that a meatus (4) can be formed. Said interactive surface (1) is then advantageously supported, e.g. by a wooden top (8) which allows then the assembly of the legs and the other parts of the piece of furniture. In FIGS. 2 (a, b) are depicted respectively a perspective and sectional view of an interactive surface (1) used to create a floor tile. Said tile is also comprises a lower plate (2) and an upper plate (3), said plates (2) and (3) being joined along their perimeter by welding or bonding to form a meatus (4). Said tile is then advantageously supported by a plate (8a) of a material suitable for bonding the tile itself on the floor.

Said upper plate (3) should be preferably in polymeric material, e.g. PVC or PMMA, transparent or translucent and of a thickness of about 1÷4 mm. Normally, small thicknesses are preferred for top tables and bigger thicknesses are preferred for tiles.

Said meatus (4) depicted in detail in FIG. 3, is filled by at least one liquid containing solid particles (7) in suspension.

Said particles (7), to produce optical effects, must be able to reflect the light in different directions according to their orientation. A spherical shaped particle is not able to vary the angle of reflection it doesn't matter how it changes its orientation compared to the incident ray of light, while a particle with a substantially two-dimensional development, like a lamina, is able to do so because it acts like a hand-mirror which can direct the reflected ray of light according to different orientations, in function of its orientation to the incident ray of light. In this way, if the majority of the particles are orientated so that their surface is substantially parallel to the plate (3) (FIG. 4a), that is the upper plate from which the light comes, an incident ray of light i will be reflected in great part towards the outward, according to the reflected ray r, consequently the surface (1) appears luminous, while if said laminas (7) are disposed with their surface in a substantially perpendicular way to said upper plate (3) (FIG. 4b), the incident ray i produces a reflected ray r′, towards the inside of the fluid mass in the meatus (4) and, consequently, the surface (1) appears dark.

According to the invention, the surface is able to change its luminosity simply by changing the orientation of the particles (7) contained in the liquid (6). Since a body immerged in an electric field tends to orientate itself with its main dimension in a parallel way to the lines of force of said electric field, said lamina-shaped particles (7), will be orientated to the surfaces in a perpendicular way to said outer plate (3), if an electric field is created with the lines of force substantially perpendicular to said outer plate (3). To allow it, anyway it is necessary that the liquid (6) in which said particles are immerged, is insulating.

Said electric field is obtained through the friction of the outer surface of the plate (3). In this way, after the removal of electrons, on the outer surface, electrical positive charges (8) are generated (FIG. 5) which induce, on the internal surface of said outer plate (3) electrical negative charges (9). In this way, an electric field is generated, in which the lines of force (10) are perpendicular to the outer plate (3), which causes the orientation of the particles, or laminas (7) to be perpendicular to said plate (3).

The result of rubbing is consequently the darkening of the surface (1) in correspondence to the areas where the rubbing took place. In fact in said areas, an incident ray of light i is reflected toward the inside (reflected ray r′), while the areas surrounding the surface (1) continues to be luminous, because an incident ray of light i produces a reflected ray of the light toward the outward r.

To annul the electric field's effect it is enough to touch again, but without rubbing, the surface in the dark areas and push on the upper plate (3) to move it closer to the lower plate (2), as indicated by arrow P, reducing the thickness of the meatus (4) (FIG. 6a). The contact with the surface neutralizes the electric charges previously induced, while pressure P, locally reducing the meatus' thickness, causes the liquid flow (6) according to the parallel planes of the plate (3) which again orientate the laminas (7) in a parallel orientation to said plate (3) (FIG. 6b). In this way an incident ray of light i will produce a reflected ray of light r and the surface (1) will appear luminous again. Practically, it happens that if starting from the situation in which the laminas (7) are orientated in a parallel way to the upper plate (3) and consequently the surface is luminous, e.g. if a finger is passed on the outer surface of said upper plate (3), in the action of writing or drawing, (FIG. 7), in correspondence to the finger's path (11) are generated said positive (8) and negative (9) charges which cause the rotation of the laminas (7) which are in the immediate closeness, with the consequence that in correspondence to finger's path (11) the surface (1) will appear dark. Briefly, if a finger is passed on the outer surface of the upper plate (3) it is possible to write and draw on the surface (1). The described operation of pressure application on the upper plate (3) will enable the writings and/or drawings made on the surface (1) to be erased. The particles (7) in suspension in the liquid (6) can be of every kind, provided that they are suitable to reflect the light in different directions according to their orientation. Those, which at the testing achieved the best results, are of the following kind:

the effect pigments made of aluminium flakes, bronze powder;

pigments made of mica flakes covered with oxides;

metal flakes covered with oxides;

silica flakes covered with oxides;

oxide aluminium covered with oxides;

inorganic flakes, of synthetic or natural origin, covered with oxides.

The dimensions of said particles (7) are advantageously comprised between 5 and 100 μm.

The liquid (6) has to be electrically insulating and it must have a viscosity preferably lower than 1000 cps, e.g. vaseline oil, silicone, alchidic resin, mineral or polymeric oils such as polybutene, polybutadiene of a low molecular weight, eventually thinned out in mineral ragia.

The meatus (4) of course must be watertight. That is why plates (2) and (3) must be linked in a continuous and reliable way all along their perimeter. The afore-mentioned conjunction can be made with known means such as bonding or welding, e.g. ultrasounds or with high frequency current. To increase the reliability of the conjunction it is suitable to insert inside the meatus (4) a chamber (4a) of the same dimension gotten by welding two sheets (12) and (13) of polymeric film of the same kind as the one used for packaging, as depicted in FIG. 8. Said film, preferably a multilayer one, which is obtained by superimposing polymeric layers of different kinds, is suitable for achieving a reliable welding through fusion, because one of the two outer layers of every sheet (12a) and (13a) has a melting temperature sensibly lower than the one of the other layers. To make a weld (14) of two sheets, the layers which melt to a lower temperature (12a) and (13a) are put together and are melted by heating them with hot bars. Owing to the presence of layers, which melt to a relatively higher temperature, said combined layers could be easily melted without weakening the sheets structure.

Moreover sheet (12) can be of metal and/or coloured in such a way to give directly a colour to the bottom, without colouring the lower plate (2).

Said chamber (4a) is then advantageously linked in a stable way to the afore mentioned plates (2) and (3), e.g. through welding or bonding, which can be achieved with the junction of said chambers (2) and (3).

According to a preferred embodiment, the meatus (4) can be filled with more then one liquid, e.g. vaseline oil or silicone, by colouring in a different way said two liquids, to achieve particular chromatic effects. Obviously to colour the first liquid, it is necessary to use dyes or pigments, which do not mix with the second one and vice versa. E.g. vaseline oil can be coloured with organic dyes, which do not colour silicone.

The interactive surface according to the invention can be used without any problem, as far as hydrostatic load is concerned, if it is in a horizontal or almost horizontal position. If the invention is used as covering for shaped or vertical surfaces, it is necessary to shape properly the meatus size, eventually by splitting it into chambers, according to the thickness of the plates (2) and (3).

The invention has been described with a purely illustrative and not imitating goal in mind. The sector's technical expert will be able to find numerous variations, all falling under the protection of the claims that follow.

1. Furnishing article of an interactive surface kind, to be used as a tile for floors and table tops and the like, comprising a flexible transparent or translucent first plate (3), coupled to a second plate (2), so that the said first plate (3) can be coupled to the said second plate (2), in order to create between the said first and second plate a meatus (4) of a small thickness which is variable according to the actions applied on the said first upper plate (3), said meatus being filled with at least one liquid which can move inside said meatus itself (4) after compression actions applied on the said first upper plate (3) which tends to move it closer to the said second lower plate (2), causing the moving of said at least one liquid, so that the said second lower plate (2) becomes visible through said first upper transparent or translucent first plate (3), characterized by the fact that said at least one liquid is insulating and contains in suspension solid particles, said solid particles being:
of the kind which reflect light,
of a shape which allows the light to be reflected according different directions in function of the orientation of said particles with respect to the incident rays of light.

2. Furnishing article according to claim 1, characterized in that said solid particles comprise laminas suitable to be orientated with their main dimension in a perpendicular direction to the said first upper plate (3), when the said upper plate (3) is rubbed on its surface.

3. Furnishing article according to claim 1, characterized in that said particles comprise laminas suitable to be orientated with their main dimension in a parallel way to the said first upper pate (3) when on the said first upper plate (3) a pressure which tends to move it closer to the said second lower plate (2) is applied, creating in this way a flow of said at least one liquid which is squeezed towards the surrounding areas of the area where the pressure is applied.

4. Furnishing article according to claim 1, characterized by the fact that the said insulating liquid has a viscosity lower than 1000 cps.

5. Furnishing article according to claim 1, characterized by the fact that said liquid is chosen among: vaseline oil, silicone, alchidic resins, mineral oils or polymers such as polybutene, polybutadiene with a low molecular weight.

6. Furnishing article according to claim 1, characterized by the fact that the said particles are chosen from among:
effect pigments made of aluminium flakes, bronze powder;
pigments made of mica flakes covered with oxides;
metal flakes covered with oxides;
silica flakes covered with oxides;
aluminium oxide covered with oxides;
inorganic flakes, of synthetic or natural origin, covered with oxides.

7. Furnishing article according to claim 1, characterized by the fact that said particles have a lamina shape.

8. Furnishing article according to claims 5, characterized by the fact that said lamina shaped particles have a dimension between the range of 5 and 100 μm.

9. Furnishing article according to claim 1, characterized by the fact that the said first plate (3) and the said second plate (2) linked along their perimeter create a watertight meatus (4).

10. Furnishing articles according to claim 1, characterized by the fact that said upper plate (3) is made of a polymeric material.

11. Furnishing article according to claim 8, characterized by the fact that said upper plate (3) is made of PVC.

12. Furnishing article according to claim 8, characterized by the fact that said upper plate (3) is made of PMMA.

13. Furnishing article according to claim 1, characterized by the fact that said liquid containing in suspension said solid particles is contained inside a watertight chamber which is contained inside the said meatus (4).

14. Furnishing article according to claim 11, characterized by the fact that the said watertight chamber is linked by welding to said plates (2) and (3).

15. Furnishing article according to claim 11, characterized by the fact that the said watertight chamber is created by using a polymeric ultrasounds weldable film.

16. Furnishing article according to claim 11, characterized by the fact that the said watertight chamber is created by using a polymeric film which is weldable by melting obtained with alternate high frequency current.

17. Furnishing article according to claim 11, characterized by the fact that the said watertight chamber is created by using a polymeric multi-layer film which is weldable by melting of the layers in contact, which have a melting temperature lower than the one of the other layers.

18. Furnishing article according to claim 11, characterized by the fact that said watertight chamber is created with a sheet of transparent polymeric material (13), placed on the side of the said first plate (3), and a sheet of metallized polymeric material.
